(19) United States
(12) Patent Application Publication
(10) Pub. No.: US 2005/0269218 A1
(43) Pub. Date: Dec. 8, 2005

(54) Kit for providing a pet meal

(75) Inventors: Gregory Dean Sunvold, Lewisburg, OH (US); Donald Gary Simpson, West Chester, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignees: The Procter & Gamble Company, Cincinnati, OH (US); The IAMS Company

(21) Appl. No.: 10/850,215

(22) Filed: May 20, 2004

(51) Int. Cl. B65D 77/00; B65D 25/08

(52) U.S. Cl. 206/219; 206/216

(57) ABSTRACT

The present invention is directed to kits and methods for providing a pet meal. The kits comprise of a first containing device comprising a first pet composition and a second containing device comprising a second pet composition, wherein the first and second pet compositions are compositionally distinct. The first and second pet compositions may be combined to provide a pet meal.

### FIELD OF THE INVENTION

The present invention relates to a first and a second containing device comprising compositionally distinct pet compositions. The invention further relates to methods for preparing pre-packaged pet compositions.

### BACKGROUND OF THE INVENTION

Pets, such as dogs and cats, often live from 15-20 years and sometimes even longer. The longevity of a pet is best served through good nutrition. Good nutrition of a pet requires supplying nutritional content in a pet composition that is both digestible and palatable to the companion animal. In addition, good nutrition provides reassurances to a pet owner that the freshest possible nutrients and flavorants are supplied to the pet.

Pet compositions are generally classified into three types by their water content: dry, semi-moist and wet pet compositions. The production of a pet composition that has the attributes of nutritional supply, digestibility and palatability to a pet presents a number of difficulties. For instance, semi-moist and wet pet compositions may be susceptible to high growth of microorganisms and may require refrigeration after opening.

Methods commonly used to minimize these effects is to dry the pet composition sufficiently to prevent microbial growth or to add preservatives to the composition. Too much drying of the composition, however, can result in a loss of nutrients and can also make the composition hard, thus reducing palatability to pets. Further, forms of heat used to dry pet compositions often increase oxidation of the compositions, thereby also decreasing the digestibility of the compositions.

A number of techniques are currently used to produce a pet composition that is palatable to a pet by maintaining a desired level of moisture while also preserving the nutritional value and digestibility of the composition. Vacuum packaging and retort packaging of semi-moist and wet pet compositions are commonly used methods to preserve nutrients in a liquid medium. Other preservation methods include the addition of preservatives, antimycotics or antibiotics to dry, semi-moist and wet pet compositions that can be harmful to a pet's health. Other methods that have been devised include storing pet compositions in a gas impermeable container as is described in U.S. Pat. Nos. 6,042,857 and 6,063,414. However, not all pet composition ingredients or desirable components are amenable to such techniques, for example, due to instability or other characteristics.

While a variety of pet composition containers and pet composition products currently exist, the need for packages with distinct pet compositions that can be mixed together for increased palatability, nutrition and digestibility of a pet composition has not been largely considered in the art.

### SUMMARY OF THE INVENTION

The present invention is directed to kits and methods for providing pet compositions. The kits comprise of a first containing device comprising a first pet composition and a second containing device comprising a second pet composition, wherein the first and second pet compositions are compositionally distinct. The first and second pet compositions may optionally be combined to provide a pet meal.

### BRIEF DESCRIPTION OF THE DRAWINGS

FIG. 1 is a perspective view of an embodiment of the first containing device and the second containing device in accordance with the present invention.

FIG. 2 is a top plan view of an embodiment of the first containing device and the second containing device in accordance with the present invention.

FIG. 3 is a cross-sectional view of an embodiment of the first containing device and the second containing device in accordance with the present invention.

FIG. 4 is a perspective view of an embodiment of the first containing device and the second containing device in a stacked position in accordance with the present invention.

FIG. 5 is a perspective view of a first containing device and a second containing device in accordance with the present invention.

FIG. 6 is a perspective view of a first containing device and a second containing device in accordance with the present invention.

### DETAILED DESCRIPTION OF THE INVENTION

Various documents, including, for example, publications and patents, are recited throughout this disclosure. All such documents are hereby incorporated by reference. The citation of any given document is not to be construed as an admission that it is prior art with respect to the present invention.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the features or embodiments as described herein. As will also be apparent, all combinations of the embodiments and features taught in the foregoing disclosure are possible and can result in preferred executions of the invention.

The present invention is directed to compositions and methods that are adapted for use by pets. As used herein, “pet” means a domestic animal. Preferably, “pet” means a domestic dog, cat, rabbit, ferret, horse, cow, or the like. More preferably, “pet” means a domestic dog or cat, particularly a domestic dog.

As used herein, the term “dry” and “dried” generally relates to a composition having a water content of less than 20% by weight, more particularly within the range of from about 6% to about 12% by weight. In addition, as used herein, the term “semi-moist” generally relates to a composition having a water content of from 20% to 40% by weight. Also, as used herein, the term “wet” generally relates to a composition having a high water content of more than 40% by weight, more particularly in the range of from about 65-85% by weight.

The term “complete and nutritionally balanced” as used herein refers to a pet composition having all known required nutrients in proper amounts and proportions based upon the recommendation of recognized authorities in the field of animal nutrition. As such, a “complete and nutritionally balanced” pet composition may be compounded to be fed as the sole ration and is capable of maintaining the life and/or promote reproduction without any additional substance being consumed, except for water.

The term “additives” as used herein refers to components that can be added to a pet composition. As one of ordinary skill in the art will recognize, such components may include, but will not be limited to: vitamins, minerals, bacteria such as probiotics, yeast or yeast cultures, fibers, other plant derived nutritional pigments such as chlorophyls and flavanoids and including carotenoids such as beta carotene, lutein, lycopene, and bixin, phytoestrogens, phytoandrogens, medicaments, palatants, aromants, digestants, and combinations thereof.

As used herein, the term “substantially transparent” with reference to all or a portion of a containing device optionally used in accordance with the current invention, means that light is transmitted through such cover and seal such that at least a part of the second containing device and at least a part of the pet composition can be viewed. The substantially transparent portion will be apparent as viewed by the eye for visual inspection.

### KITS OF THE PRESENT INVENTION

The present invention relates to kits comprising a first containing device and a second containing device wherein the contents of the first and second containing device are compositionally distinct. The containing devices may be of any desired shape or size to accommodate pet compositions. In one embodiment of the current invention, the first containing device comprises a dry, semi-moist or wet pet composition and is associated with the second containing device comprising a wet, semi-moist or dry pet composition comprising one or more additives that can be mixed or otherwise contacted with the pet composition in the first containing device. In other embodiments, the first containing device comprises a complete and nutritionally balanced pet composition and the second containing device comprises a complete and nutritionally balanced pet composition that can be added to the pet composition in the first containing device. Yet still in further embodiments, the first containing device comprises a pet composition comprising one or more additives and the second containing device independently comprises a pet composition comprising one or more additives that may be added to the pet composition in the first containing device.

More specifically, in the present invention a second containing device comprising a pet composition may optionally contain one or more of the following additives: bacteria such as probiotics, yeast or yeast cultures, vitamins, minerals, fibers, other plant derived nutritional pigments such as chlorophyls and flavanoids and including carotenoids such as beta carotene, lutein, lycopene, and bixin, phytoestrogens, phytoandrogens, medicaments, palatants, aromants, and digestants.

### EMBODIMENTS OF THE PRESENT INVENTION

For example, the first and second containing device can be independently selected from any of the following: a plastic container, a metal container, a bottle, a pouch, a sachet, a box, a can, a paper bag, a plastic bag, ard combinations thereof. The containing device used in the current invention may be made of any of a variety of materials. For example, plastic, paper, paperboard, metal, cloth, cheesecloth, netting, foil and the like may be used. To illustrate, in one embodiment of the current invention, plastic sheets are used to form the first containing device and the second containing device has an outer layer made of paper and an inner layer made of foil.

In one embodiment of the current invention, the second containing device is a releasable sachet comprising one or more additives. For example, the sachet may be housed between a transparent freshness seal covering a pet composition in a first containing device that is a plastic container and a transparent cover that allows consumers to view both the nutrient containing sachet and the pet composition. Such an embodiment is described in detail below.

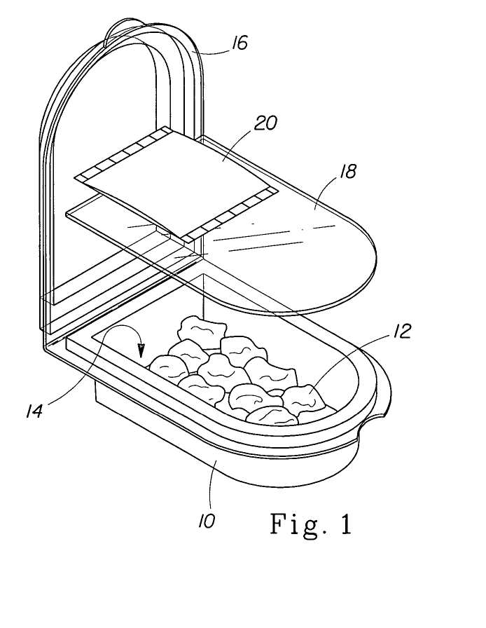

A kit comprising a shaped, plastic container for sealing a pet composition and further comprising a visible sachet 20 in accordance with the present invention is illustrated in FIG. 1. The plastic container includes a body 10 that is designed to support a quantity of pet composition 12. The container shown in FIG. 1 has been chosen as an embodiment that provides a substantially stress-free condition that maximizes strength imparted to the container and ease of opening and closing the container. The body 10 of the plastic container in accordance with the preferred embodiment of the current invention comprises an open mouth 14 wherein a substantially transparent removable seal 18 is used to maintain the freshness of pet composition 12. Sachet 20 is maintained above the substantially transparent removable seal 18 and under substantially transparent cover 16. In this embodiment, substantially transparent cover 16 is attached to body 10 in a hinged mechanism. The substantially transparent removable seal 18 and the substantially transparent cover 16 allow a consumer to view the sachet 20 and pet composition 12 prior to purchasing the kit.

A second containing device in accordance with the preferred embodiment of the current invention may contain any variety of additives for a pet composition. In one embodiment of the current invention the sachet 20 contains one or more additives that may not survive the dry composition extrusion process used to produce pet composition 12. In the preferred embodiment, a consumer will open the sachet 20 and mix the additives with the pet composition 12 prior to consumption by a pet. Mixture of an additive with a pet composition provides benefits to a pet meal for a pet. In one embodiment the pet meal is complete and nutritionally balanced.

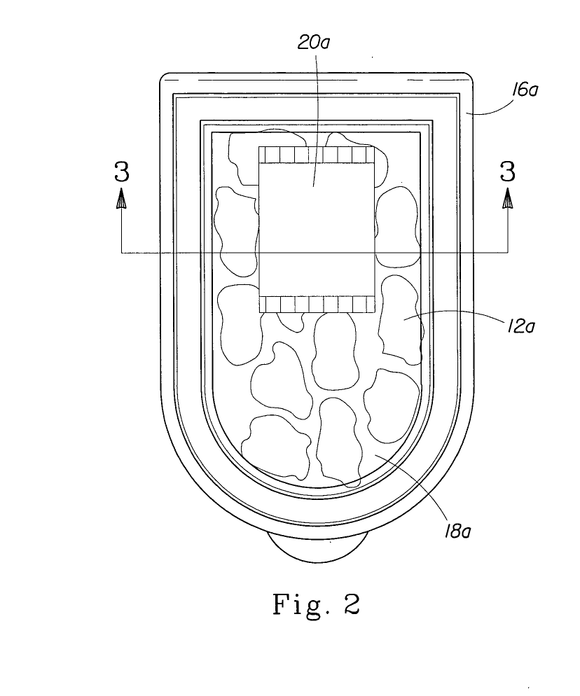

Another view of a preferred embodiment in accordance with the present invention is illustrated in FIG. 2 of the drawings, and is generally similar to the previous embodiments as indicated by the application of identical reference numerals with the suffix a for similar parts. FIG. 2 illustrates a top plan view of the preferred embodiment. The substantially transparent cover 16a is closed upon the body of the container allowing the sachet 20a containing additives to be viewed by a consumer prior to purchase. Additionally, pet composition 12a is visible through substantially transparent cover 16a and substantially transparent seal 18a.

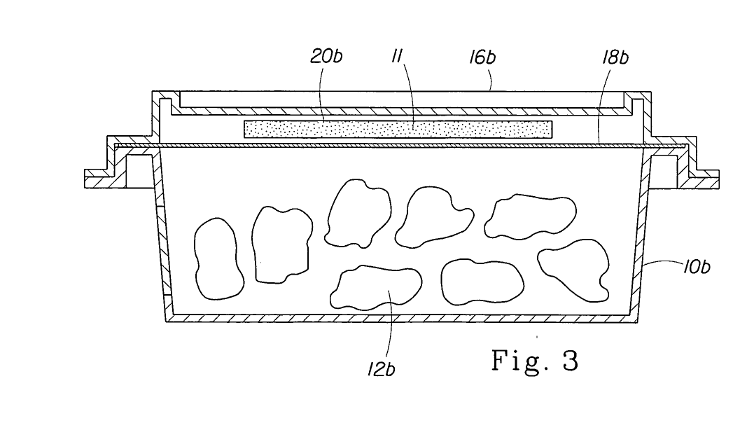

FIG. 3 indicates identical reference numerals with the suffix b for parts similar to previous embodiments. FIG. 3 shows a cross-sectional view of the preferred embodiment of the current invention, showing additives 11 in sachet 20b. Cover 16b is closed upon the body of the container 10b. Seal 18b is shown firmly enclosing pet composition 12b to maintain freshness. Sachet 20b is shown in FIG. 3 housed between substantially transparent cover 16b and substantially transparent seal 18b and holding additive 11.

In addition, in embodiments of the current invention, the second containing device may comprise an inner lining that provides partial or total resistance to light, inhibits moisture from entering the containing device, and inhibits air from entering the containing device. In one embodiment the second containing device is a sachet comprising an inner layer preferably made of a foil material and an outer layer preferably made of a paper material.

The second containing device, shown as sachet 20 in FIG. 1 can be any size or shape that will fit within the space provided between the substantially transparent seal 18 and the substantially transparent cover 16. In one embodiment of the invention, the first containing device is configured to contain 3 ounces, 6 ounces, or 12 ounces of a pet composition. Containing devices configured to contain from about 2 ounces to about 20 ounces of a pet composition can also be readily formed and any larger or smaller sized containers to accommodate a pet composition and is a further embodiment that is disclosed in accordance with the current invention.

In accordance with one embodiment and the figures shown, the second containing device is smaller in size than the first containing device. The first containing device is formed to contain a pet meal that can be served on its own to a pet. The second containing device is formed to contain a nutrient or other additive that can be topped or mixed with a pet meal. As such, in this embodiment the second containing device is smaller than the first containing device in the preferred embodiment of the current invention. However, the ordinarily skilled artisan will appreciate that this is not intended to limit the invention.

In other embodiments of the containing device shown in FIG. 1-4, a seal can be opaque, translucent or substantially transparent as described in the foregoing embodiment. In addition, in these or other embodiments of the containing device shown in FIG. 1-4, the cover of a containing device can be opaque, translucent or substantially transparent. While in one embodiment at least a portion of the seal and the cover are at least partially substantially transparent, in other embodiments both the seal and the cover are opaque.

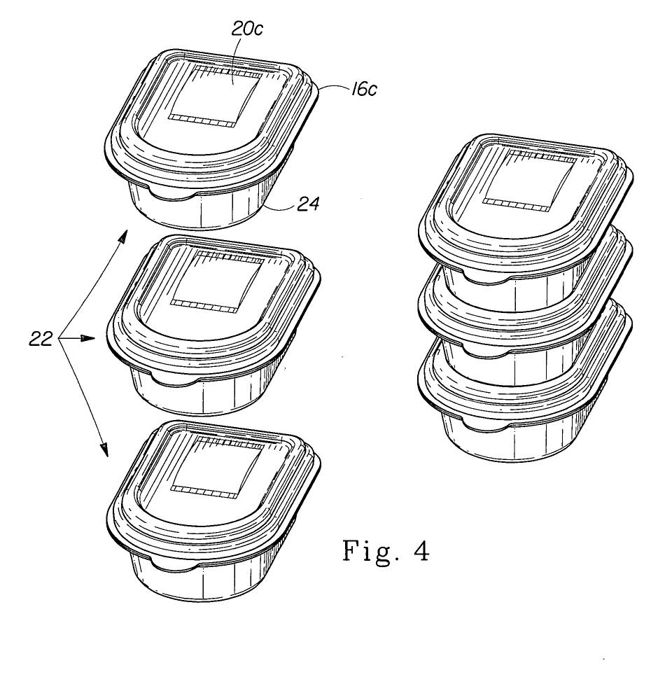

FIG. 4 indicates identical reference numerals with the suffix c to indicate parts similar to previous embodiments. Stackability is an attribute of the first containing device in one embodiment of the current invention. As shown in FIG. 4, first containing device plastic container 22 containing second containing device sachet 20c under cover 16c are shown stacked by placing the cover 16c in a facing relationship with the base 24 of another plastic containing device 22. In this embodiment, stackability provides for convenient storage of the first containing device in accordance with the current invention. In addition, stackability allows the first containing device to be easily wrapped for multiple sale.

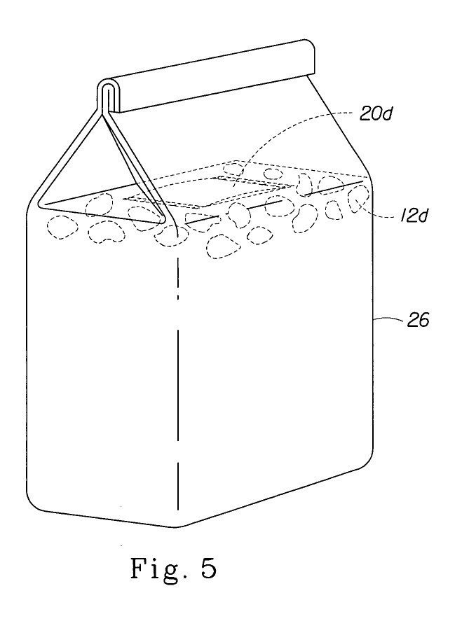

FIG. 5 indicates identical reference numerals with the suffix d for parts similar to previous embodiments. FIG. 5 shows an embodiment of the current invention wherein a second containing device sachet 20d optionally containing an additive is contained within first containing device bag 26 containing a dry pet composition 12d. In this embodiment, a dry pet composition 12d is housed in the plastic bag 26, and a wet or semi-moist composition is housed in the sachet 20d for topping the dry pet composition 12d.

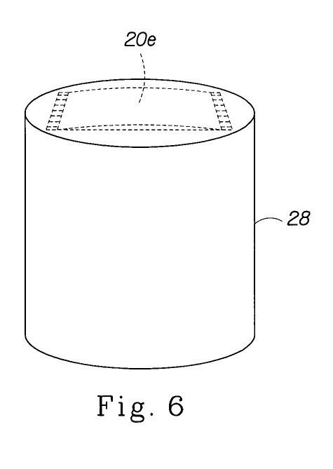

FIG. 6 indicates identical reference numerals with the suffix e for parts similar to previous embodiments. FIG. 6 shows an embodiment of the current invention wherein a second containing device sachet 20e containing an additive is releasably associated with a first containing device can 28 containing a pet composition. In accordance with this embodiment, the contents of the sachet 20e can be mixed with the pet composition housed in can 28 when can 28 is opened.

In the embodiment shown in FIG. 6 the cans are stackable for easy storage. In this embodiment, the cans be placed on top of each other in a stackable position.

In further embodiments of the current invention a first and second containing device are provided wherein the contents of the first and second containing device are compositionally distinct and wherein the contents of the first and second containing device are automatically combined when the first containing device is opened. In one embodiment, the second containing device is a sachet that is associated with a first containing device which is a plastic container as shown in FIG. 1. In this embodiment, the sachet is positioned and attached under a seal such that the frangible closure of the sachet is cotaminous with an edge of the container at the seal point. When the seal is opened the contents of the sachet are automatically topped onto a pet composition in the first containing device as the seal is stripped away. In this embodiment, a pet owner can further combine the first and second compositions by mixing.

In another embodiment, a first containing device and a second containing device are both pouches. In this embodiment, the second containing device has a recloseable seal such that a pet owner can use a portion of the composition within the second containing device and store the remaining contents in the recloseable pouch. In one embodiment, the first containing pouch houses a wet composition and the second containing pouch houses a dried additive.

In a further embodiment, a second containing device is a pouch housed adjacent to a pet composition in a first containing device plastic container and is separated by a divider. In this embodiment, removal of the divider automatically opens the pouch such that the contents of the pouch are expelled onto a pet composition and can thereby be mixed together by the pet owner. Yet still in another embodiment of the current invention, a pouch or other second containing device automatically opens for the addition of additives to a pet composition housed within a can. In this embodiment the second containing device is automatically opened when the can is opened.

In other embodiments of the current invention, a first containing device and a second containing device are both plastic containers, wherein the first containing device houses a pet composition and the second containing device houses an additive. In this embodiment, the pet composition in the first containing device is topped with the additive housed in the second containing device by a pet owner. In other embodiments, the first containing device is a plastic container and the second containing device is a metal container, a sachet, a pouch, a bottle, a bag, a can, a box and combinations thereof.

In yet a further embodiment of the current invention, a first containing device is a box housing a dry pet composition and a second containing device is a bottle housing a wet nutrient additive. In this embodiment, a pet owner can add a desired amount of dried pet composition to a feeding dish and then top the dried pet composition with a desired amount of wet nutrient additive. In other variations of this embodiment the first containing device is a box housing a semi-moist pet composition and the second containing device is a smaller box attached to the first containing device. In this embodiment, the second containing device contains a dried medicament to add to a pet composition for treatment or prevention of disease.

In other embodiments of the current invention a first containing device and a second containing device are both cans. In this embodiment, a pet owner can optionally open the second containing device containing additives to add to a pet composition or the pet owner can store the second containing device for future use. Yet still in further embodiments, the first containing device is a can and the second containing device is a box. In this embodiment, additives are contained in the box and may be added to a pet composition contained in the can when the can is opened.

A method for providing a pet composition to a pet is further disclosed in the present invention. In one embodiment a first containing device comprising a first pet composition is associated with a second containing device comprising a second pet composition. The first and second containing device may be disassociated such that the second pet composition and the first pet composition can be manually or automatically combined. In one embodiment, the first pet composition and the second pet composition are compositionally distinct. The first pet composition in accordance with the method disclosed is selected from the group consisting of: a wet pet composition, a dry pet composition, a semi-moist pet composition, and combinations thereof. In addition, the second pet composition is selected from the group consisting of: a wet additive, a dry additive, a semi-moist additive and combinations thereof. The first and second containing devices in accordance with the method disclosed are each, independently, selected from the group consisting of plastic containers, metal containers, bottles, pouches, sachets, boxes, cans, paper bags, plastic containers and combinations thereof.

In another method disclosed in an embodiment of the invention, a pre-packaged pet meal is provided by placing a pet composition in a receptacle portion of a container. In this embodiment, a sealing means is used to provide freshness to the pet composition which may be removed for access to the pet composition. Above the sealing means a second containing device containing additives that can be added to the pet composition is enclosed by a removable cover that may be reclosed over the pet composition once it is opened. In this embodiment, a substantially transparent portion is provided on the pre-packaged pet meal, such that at least a part of the pet composition and at least a part of the second containing device can be viewed by consumers prior to purchase.

Other variations of a method of providing a pre-packaged pet meal will be readily apparent based on the various embodiments of the current invention, as described herein.

### EXAMPLE 1

A kit for providing a meal to a pet comprising:

Component
A plastic container
A pouch
A cover
A seal
A beef flavored pet composition
A beta-carotene additive

Wherein, the first containing device is the plastic container with the cover placed in a facing relationship with the body of the plastic container. The seal is releasably attached to an open mouth of the first containing device. In this embodiment, the seal and cover are at least in part substantially transparent for viewing at least a portion of the second containing device, which is the pouch, and at least a portion of the pet composition. The beef flavored pet composition may comprise of beef chunk, vegetables, imitation meat product, lentils, rice, beans, along with flavorants, colorants, aromants, digestants and combinations thereof, and wherein the beta carotene is a nutrient additive that a pet owner may add to the beef flavored pet composition prior to feeding.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those ordinarily skilled in the art that various other changes and modifications can be made without departing from the spirit and scope of the invention. It is therefore intended to cover in the appended claims all such changes and modification that are within the scope of this invention.

1. A kit comprising:
(a) a first containing device comprising a first pet composition; and
(b) a second containing device associated with said first containing device, said second containing device comprising a second pet composition;
wherein, said first pet composition and said second pet composition are compositionally distinct.

2. The kit in accordance with claim 1 wherein said first pet composition is selected from the group consisting of: dry pet compositions, semi-moist pet compositions, wet pet compositions, and mixtures thereof.

3. The kit in accordance with claim 2 wherein said second pet composition comprises an additive.

4. The kit in accordance with claim 3 wherein said additive is selected from the group consisting of dried additives, semi-moist additives, wet additives and combinations thereof.

5. The kit in accordance with claim 4 wherein said additive is selected from the group consisting of: bacteria, yeast culture, fibers, pigments, carotenoids, phytoestrogens, phytoandrogens, medicaments, palatants, nutrients, digestants, aromants, and combinations thereof.

6. The kit in accordance with claim 5 wherein said first containing device and said second containing device are each, independently, selected from the group consisting of: plastic containers, metal containers, bottles, pouches, sachets, boxes, cans, paper bags, plastic bags, and combinations thereof.

7. The kit in accordance with claim 6 wherein said first containing device is a plastic container and said second containing device is a sachet.

8. The kit in accordance with claim 7 wherein said plastic container comprises a substantially transparent seal.

9. The kit in accordance with claim 8 wherein said plastic container comprises a substantially transparent cover.

10. The kit in accordance with claim 7 wherein said first pet composition is said wet pet composition and wherein said second pet composition comprises said dried additive.

11. The kit in accordance with claim 7 wherein said first pet composition is said semi-moist pet composition and said second pet composition comprises said dried additive.

12. The kit in accordance with claim 7 wherein said first pet composition is said dried pet composition and said second pet composition comprises said wet additive.

13. The kit in accordance with claim 1 comprising a plurality of first containing devices and a plurality of second containing devices.

14. A method for providing a pet composition to a companion animal comprising:
obtaining the kit in accordance with claim 1;
disassociating said second containing device from said first containing device; and,
combining said second pet composition with said first pet composition.

15. The method in accordance with claim 14 wherein said first pet composition and said second pet composition are combined by a pet owner.

16. The method in accordance with claim 15 wherein said second pet composition is automatically mixed with said first pet composition when said first containing device is opened.

17. The method in accordance with claim 16 wherein said first containing device is a plastic container comprising a dry pet composition and said second pet containing device is a sachet comprising a wet additive.

18. The method in accordance with claim 16 wherein said first containing device is a plastic container comprising a semi-moist pet composition and said second containing device is a sachet comprising a dry additive.

19. The method in accordance with claim 16 wherein said first containing device is a plastic container comprising a wet pet composition and said second containing device is a sachet comprising a dry additive.
